(19) United States
(12) Patent Application Publication
(10) Pub. No.: US 2013/0106330 A1
(43) Pub. Date: May 2, 2013

(54) RECTIFIER AND INVERTER BASED TORSIONAL MODE DAMPING SYSTEM AND METHOD

(71) Applicants: Simon Herbert Schramm, Munchen (DE); Christof Martin Sihler, Munchen (DE); Alfredo Sebastian Achilles, Bavaria (DE); Paola Rotondo, Firenze (IT)

(72) Inventors: Simon Herbert Schramm, Munchen (DE); Christof Martin Sihler, Munchen (DE); Alfredo Sebastian Achilles, Bavaria (DE); Paola Rotondo, Firenze (IT)

(73) Assignee: NUOVO PIGNONE S.p.A., Florence (IT)

(21) Appl. No.: 13/638,846

(22) PCT Filed: Mar. 30, 2011
(86) PCT No.: PCT/EP11/54948

§ 371 Date: Dec. 13, 2012

(30) Foreign Application Priority Data
Apr. 1, 2010 (IT) CO2010A000011

(51) Int. Cl. H02P 27/06

(52) U.S. Cl. CPC H02P 27/06
USPC 318/400.15

(57) ABSTRACT

A torsional mode damping controller system is connected to a converter that drives a drive train including an electrical machine and a non-electrical machine. The controller system includes an input interface configured to receive measured data related to variables of the converter or the drive train and a controller connected to the input interface. The controller is configured to calculate at least one dynamic torque component along a section of a shaft of the drive train based on the measured data from the input interface, generate control data for a rectifier and an inverter of the converter for damping a torsional oscillation in the shaft of the drive train based on the at least one dynamic torque component, and send the control data to the rectifier and to the inverter for modulating an active power exchanged between the converter and the electrical machine.

### CROSS REFERENCE TO RELATED APPLICATIONS

This is a national stage application under 35 U.S.C. §371(c) of prior-filed, co-pending PCT patent application serial number PCT/EP2011/054948, filed on Mar. 30, 2011, which claims priority to Italian Patent Application Serial No. CO2010A000011, filed on Apr. 1, 2010, the entire contents of which are incorporated herein by reference.

### BACKGROUND OF THE INVENTION

Embodiments of the subject matter disclosed herein, generally relate to methods and systems and, more particularly, to mechanisms and techniques for dampening a torsional vibration that appears in a rotating system.

The oil and gas industry has a growing demand for driving various machines at variable speeds. Such machines may include compressors, electrical motors, expanders, gas turbines, pumps, etc. Variable frequency electrical drives increase energy efficiency and provide an increased flexibility for the machines. One mechanism for driving, for example, a large gas compression train is the load commutated inverter (LCI). A gas compression train includes, for example, a gas turbine, a motor, and a compressor. The gas compression train may include more or less electrical machines and turbo-machines. However, a problem introduced by power electronics driven systems is the generation of ripple components in the torque of the electrical machine due to electrical harmonics. The ripple component of the torque may interact with the mechanical system at torsional natural frequencies of the drive train, which is undesirable.

A torsional oscillation or vibration is an oscillatory angular motion that may appear in a shaft having various masses attached to it as shown for example in FIG. 1. FIG. 1 shows a system 10 including a gas turbine 12, a motor 14, a first compressor 16 and a second compressor 18. The shafts of these machines are either connected to each other or a single shaft 20 is shared by these machines. Because of the impellers and other masses distributed along shaft 20, a rotation of the shaft 20 may be affected by torsional oscillations produced by the rotation with different speeds of the masses (impellers for example) attached to the shaft.

As discussed above, the torsional vibrations are typically introduced by the power electronics that drive the electrical motor. FIG. 1, for example, shows a power grid source (power source) 22 providing electrical power to the LCI 24, which in turn drives the shaft 20 of the motor 14. The power grid may be an isolated power generator. In order to damp (minimize) the torsional vibrations, as shown in FIG. 2 (which corresponds to FIG. 1 of U.S. Pat. No. 7,173,399, assigned to the same assignee as this application, the entire disclosure of which is incorporated here by reference), an inverter controller 26 may be provided to an inverter 28 of the LCI 24 and may be configured to introduce an inverter delay angle change (Δβ) for modulating an amount of active power transferred from inverter 28 to motor 14. Alternatively, a rectifier controller 30 may be provided to a rectifier 32 and may be configured to introduce a rectifier delay angle change (Δα) for modulating the amount of active power transferred from the generator 22 to a DC-link 44 and thus to the motor 14. It is noted that by modulating the amount of active power transferred from the generator 22 to the motor 14 it is possible to damp the torsional vibrations that appear in the system including motor 14 and gas turbine 12. In this regard, it is noted that shafts of motor 14 and gas turbine 12 are connected to each other while a shaft of generator 22 is not connected to either the motor 14 or gas turbine 12.

The two controllers 26 and 30 receive as input, signals from sensors 36 and 38, respectively, and these signals are indicative of the torque experienced by the motor 14 and/or the generator 22. In other words, the inverter controller 26 processes the torque value sensed by sensor 36 for generating the inverter delay angle change (Δβ) while the rectifier controller 30 processes the torque value sensed by the sensor 38 for generating the rectifier delay angle change (Δα). The inverter controller 26 and the rectifier controller 30 are independent from each other and these controllers may be implemented together or alone in a given system. FIG. 2 shows that sensor 36 monitors a part (section) 40 of the shaft of the motor 14 and sensor 38 monitors a shaft 42 of the power generator 22. FIG. 2 also shows the DC link 44 between the rectifier 32 and the inverter 28.

However, determining individually either the rectifier delay angle change (Δα) or the inverter delay angle change (Δβ) is not always practical and/or accurate. Accordingly, it would be desirable to provide systems and methods that use other approaches for damping the vibrational oscillations.

### BRIEF DESCRIPTION OF THE INVENTION

According to an exemplary embodiment, there is a torsional mode damping controller system connected to a converter that drives a drive train including an electrical machine and a non-electrical machine provided. The controller system includes an input interface configured to receive measured data related to variables of the converter or the drive train and a controller connected to the input interface. The controller is configured to calculate at least one dynamic torque component along a section of a shaft of the drive train based on the measured data from the input interface, generate control data for a rectifier and an inverter of the converter for damping a torsional oscillation in the shaft of the drive train based on the at least one dynamic torque component, and send the control data to the rectifier and to the inverter for modulating an active power exchanged between the converter and the electrical machine.

According to another exemplary embodiment, there is a system for driving an electrical machine that is part of a drive train provided. The system includes a rectifier configured to receive an alternative current from a power source and to transform the alternative current into a direct current; a direct current link connected to the rectifier and configured to transmit the direct current; an inverter connected to the direct current link and configured to change a received direct current into an alternative current, an input interface configured to receive measured data related to variables of the converter or the drive train; and a controller connected to the input interface. The controller is configured to calculate at least one dynamic torque component along a section of a shaft of the drive train based on the measured data from the input interface generate control data for the rectifier and for the inverter for damping a torsional oscillation in the shaft of the mechanical system based on the at least one dynamic torque component, and send the control data to the rectifier and the inverter for modulating an active power exchanged between the converter and the electrical machine.

According to still another exemplary embodiment, there is a method for damping a torsional vibration in a drive train including an electrical machine provided. The method includes receiving measured data related to variables of a converter that drives the electrical machine or the drive train or both the converter and the drive train calculating at least one dynamic torque component along a section of a shaft of the drive train based on the measured data; generating control data for a rectifier and an inverter of the converter for damping a torsional oscillation in the shaft of the drive train based on the at least one dynamic torque component; and sending the control data to the rectifier and the inverter for modulating an active power exchanged between the converter and the electrical machine.

According to yet another exemplary embodiment, there is a computer readable medium including computer executable instructions, where the instructions, when executed, implement a method for damping torsional vibrations provided. The computer instructions include the steps recited in the method noted in the previous paragraph.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional gas turbine connected to an electrical machine and two compressors;

FIG. 2 is a schematic diagram of a driving train including rectifier controller and inverter controller;

FIG. 3 is a schematic diagram of a gas turbine, motor and load controlled by a controller according to an exemplary embodiment;

FIG. 4 is a schematic diagram of a converter and associated logic according to an exemplary embodiment;

FIG. 5 is a schematic diagram of a converter and associated logic according to an exemplary embodiment;

FIG. 6 is a graph illustrating a torque of a shaft with disabled damping control;

FIG. 7 is a graph illustrating a torque of a shaft with enabled damping control according to an exemplary embodiment;

FIG. 8 is a schematic diagram of a converter and associated logic according to an exemplary embodiment;

FIG. 9 is a schematic diagram of a controller configured to control a converter for damping torsional vibrations according to an exemplary embodiment;

FIG. 10 is a schematic diagram of a controller that provides modulation to a rectifier according to an exemplary embodiment;

FIG. 11 is a flow chart of a method that controls a rectifier for damping torsional vibrations according to an exemplary embodiment;

FIG. 12 is a schematic diagram of a controller that provides modulation to a rectifier and an inverter according to an exemplary embodiment;

FIG. 13 is a schematic diagram of voltages existent to an inverter, rectifier and DC link of a converter according to an exemplary embodiment;

FIG. 14 is a graph indicating the torsional effect of alpha and beta angle modulations according to an exemplary embodiment;

FIG. 15 is a flow chart of a method that controls an inverter and a rectifier for damping torsional vibrations according to an exemplary embodiment;

FIG. 16 is a schematic diagram of a voltage source inverter and associated controller for damping torsional vibrations according to an exemplary embodiment; and

FIG. 17 as a schematic diagram of a multi mass system.

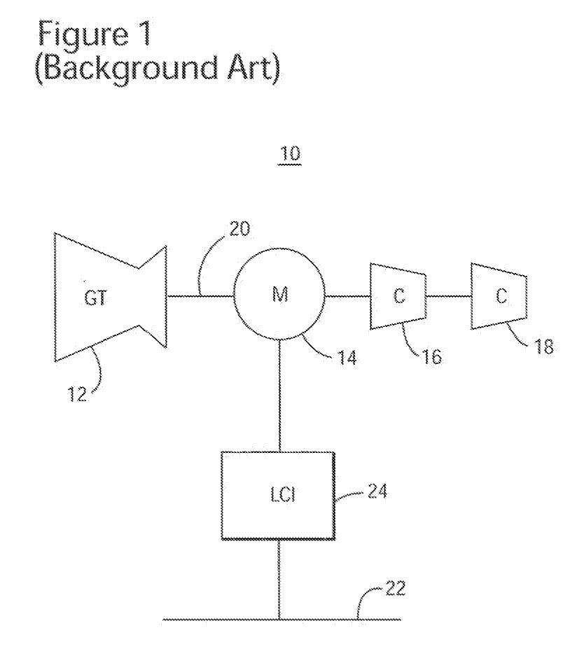

### DETAILED DESCRIPTION OF THE EXEMPLARY EMBODIMENTS OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of an electrical motor driven by a load commutated inverter. However, the embodiments to be discussed next are not limited to such a system, but may be applied (with appropriate adjustments) to other systems that are driven with other devices, as for example, a voltage source inverter (VSI).

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment, a torsional mode damping controller may be configured to obtain electrical and/or mechanical measurements regarding a shaft of an electrical machine (which may be a motor or a generator) and/or a shaft of a turbo-machine that is mechanically connected to the electrical machine and to estimate, based on the electrical and/or mechanical measurements, dynamic torque components and/or a torque vibration at a desired shaft location of a drive train. The dynamic torque components may be a torque, a torsional position, torsional speed or a torsional acceleration of the shaft. Based on one or more dynamic torque components, a controller may adjust/modify one or more parameters of a rectifier that drives the electrical machine to apply a desired torque for damping the torque oscillation. As will be discussed next, there are various data sources for the controller for determining the damping based on the rectifier control.

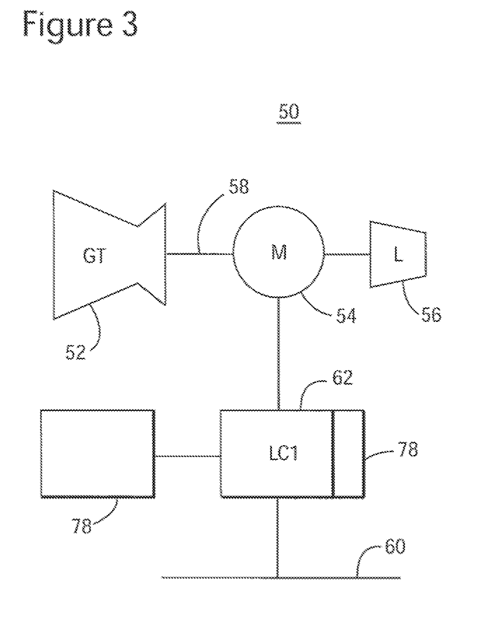

According to an exemplary embodiment shown in FIG. 3, a system 50 includes a gas turbine 52, a motor 54, and a load 56. Other configurations involving a gas turbine and/or plural compressors or other turbo-machines as load 56 are possible. Still, other configurations may include one or more expanders, one or more power generators, or other machines having a rotating part, for example, wind turbines, gearboxes. The system shown in FIG. 3 is exemplary and is simplified for a better understanding of the novel features. However, one skilled in the art would appreciate that other systems having more or less components may be adapted to include the novel features now discussed.

The connection of various masses (associated with the rotors and impellers of the machines) to a shaft 58 makes the system 50 prone to potential torsional vibrations. These torsional vibrations may twist the shaft 58, which may result in significant lifetime reduction or even destruction of the shaft system (which may include not only the shaft or shafts but also couplings and gearbox depending on the specific situation). The exemplary embodiments provide a mechanism for reducing the torsional vibrations.

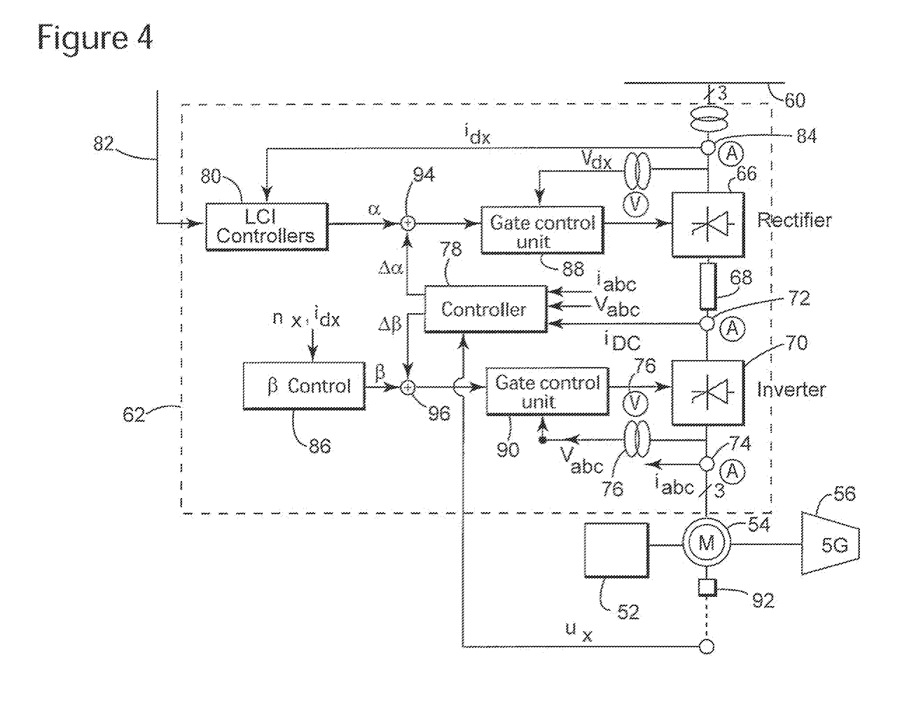

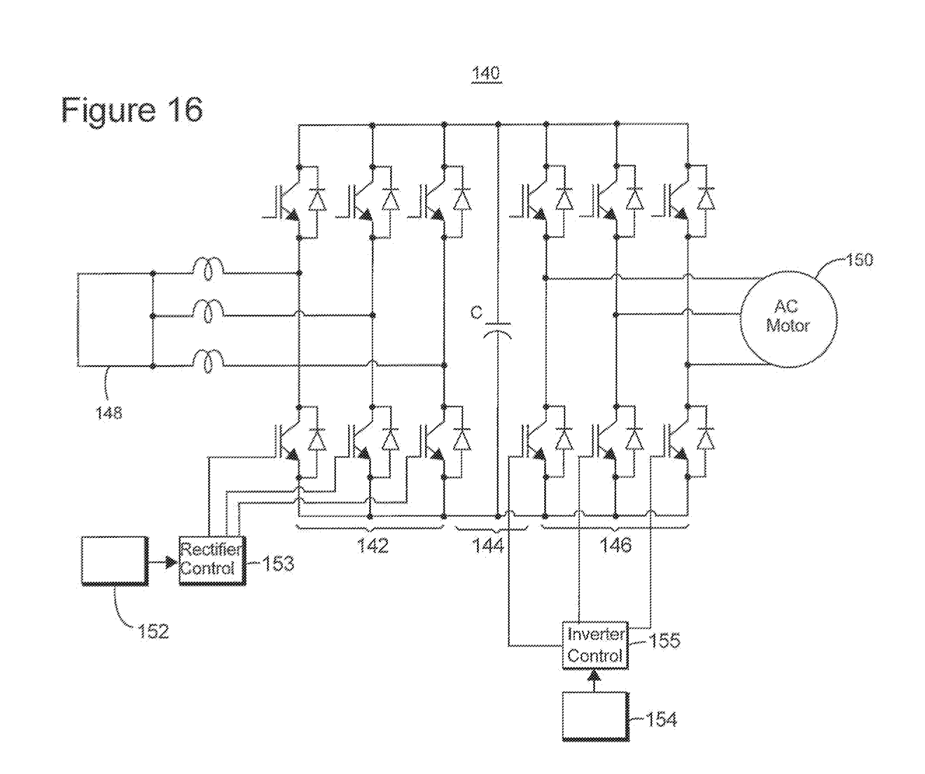

To activate the motor 54, electrical power is supplied from the power grid or a local generator 60 in case of island or island like power systems. In order to drive the motor 54 at a variable speed, a load commutated inverter (LCI) 62 is provided between the grid 60 and the motor 54. As shown in FIG. 4, the LCI 62 includes a rectifier 66 connected to a DC link 68 which is connected to an inverter 70. The rectifier 66, DC link 68, and inverter 70 are known in the art and their specific structures are not discussed here further. As noted above, the novel features may be applied, with appropriate changes, to VSI systems. For illustration only, an exemplary VSI is shown and briefly discussed with regard to FIG. 16. FIG. 4 indicates that the current and voltage received from the grid 60 are three phase currents and voltages, respectively. The same is true for the currents and voltages through the rectifier, inverter and the motor and this fact is indicated in FIG. 4 by symbol “/3”. However, the novel features of the exemplary embodiments are applicable to systems configured to work with more than three phases, for example, 6 phase and 12 phase systems.

LCI 62 also includes current and voltage sensors, denoted by a circled A and a circled V in FIG. 4. For example, a current sensor 72 is provided in the DC link 68 to measure a current inc. Alternatively, the current in the DC link is calculated based on measurements performed in the AC side, for example current sensors 84 or 74 as these sensors are less expensive than DC sensors. Another example is a current sensor 74 that measures a current i_{abc} provided by the inverter 70 to the motor 54 and a voltage sensor 76 that measures a voltage v_{abc} provided by the inverter 70 to the motor 54. It is noted that these currents and voltages may be provided as input to a controller 78. The term “controller” is used herein to encompass any appropriate digital, analog, or combination thereof circuitry or processing units for accomplishing the designated control function. Returning to FIG. 3, it is noted that controller 78 may be part of the LCI 62 or may be a stand alone controller exchanging signals with the LCI 62. The controller 78 may be a torsional mode damping controller.

FIG. 4 also shows that an LCI controller 80 may receive mechanical measurements regarding one or more of the gas turbine 52, the motor 54 and the load 56 shown in FIG. 3. The same may be true for controller 78. In other words, controller 78 may be configured to receive measurement data from any of the components of the system 50 shown in FIG. 3. For example, FIG. 4 shows a measurement data source 79. This data source may provide mechanical measurements and/or electrical measurements from any of the components of the system 50. A particular example that is used for a better understanding and not to limit the exemplars embodiments is when data source 79 is associated with the gas turbine 52. A torsional position, speed, acceleration or torque of the gas turbine 52 may be measured by existing sensors. This data may be provided to controller 78 as shown in FIG. 4. Another example is electrical measurements taken at the converter 62 or motor 54. Data source 79 may provide these measurements to controller 78 or controller 80 if necessary.

Controller 80 may generate, based on various references 82, and a current i_{dx} received from a sensor 84, a rectifier delay angle α for controlling the rectifier 66. Regarding the rectifier delay angle α, it is noted that LCIs are designed to transfer active power from the grid 60 to the motor 54 or vice versa Achieving this transfer with an optimal power factor involves the rectifier delay angle α and the inverter delay angle β. The rectifier delay angle α may be modulated by applying, for example, a sine wave modulation to a reference value. This modulation may be applied for a limited amount of time. In one application, the modulation is applied continuously but the amplitude of the modulation varies. For example, as there is no torsional vibration in the shaft, the amplitude of the modulation may be zero, that is, no modulation only the reference value. In another example, the amplitude of the modulation may be proportional with the detected torsional vibration of the shaft.

Another controller 86 may be used for generating an inverter delay angle β for the inverter 70. Modulating the inverter delay angle β results in modulating the inverter DC voltage which causes a modulation of the DC link current and results in an active power oscillation on the load input power. In other words, modulating only the inverter delay angle in order to achieve torsional mode damping results in the damping power coming mainly from the magnetic energy stored in the DC link 68. Modulation of the inverter delay angle results in rotational energy being transformed into magnetic energy and vice versa, depending whether the rotating shaft is accelerated or decelerated.

Further FIG. 4 shows a gate control unit 88 for the rectifier 66 and a gate control unit 90 for the inverter 70 that directly control the rectifier and inverter based on information received from controllers 80 and 86. An optional sensor 92 may be located in close proximity to the shaft of the motor 54 for detecting the dynamic torque components, for example, a torque present in the shaft or a torsional speed of the shaft or a torsional acceleration of the shaft or a torsional position of the shaft. Other similar sensors 92 may be placed between motor 54 and gas turbine 52 or at gas turbine 52. Information uₓ regarding measured dynamic torque components (by sensors 92) may be provided to controllers 78, 80 and 86. FIG. 4 also shows summation blocks 94 and 96 that add a signal from controller 78 to signals generated by controllers 80 and 86.

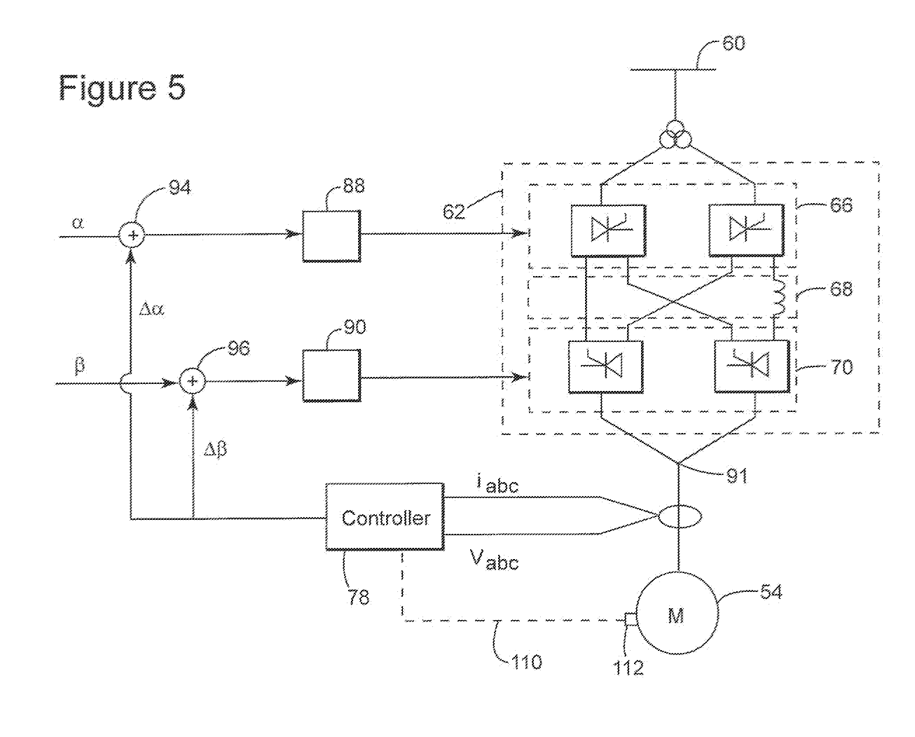

According to an exemplary embodiment illustrated in FIG. 5, the torsional mode damping controller 78 may receive a current i_{abc} and a voltage v_{abc} measured at an output 91 of the LCI 62 or the inverter 70. Based on these values (no information about a measured torque or speed or acceleration of the shaft of the motor), an air gap torque for the motor is calculated and fed into a mechanical model of the system. The mechanical model of the system may be represented by several differential equations representing the dynamic behavior of the mechanical system and linking the electrical parameters to the mechanical parameters of the system. The model representation includes, for example, estimated inertia, damping and stiffness values (which can be verified by field measurements) and allows to calculate the dynamic behavior of the shaft, for example, torsional oscillations. The needed accuracy for torsional mode damping may be achieved as mainly the accuracy of the phase of the dynamic torque component is relevant for the torsional mode damping, and the amplitude information or absolute torque value is less important.

In this regard it is noted that the air gap torque of an electrical machine is the link between the electrical and mechanical system of a drive train. All harmonics and inter-harmonics in the electrical system are also visible in the air-gap torque. Inter-harmonics at a natural frequency of the mechanical system can excite torsional oscillations and potentially result into dynamic torque values in the mechanical system above the rating of the shaft. Existing torsional mode damping systems may counteract such torsional oscillations but these systems need a signal representative of the dynamic torque of the motor and this signal is obtained from a sensor that effectively monitors the shaft of the motor or shaft components of the motor, such as toothwheels mounted along the shaft of the motor. According to exemplary embodiments, no such signal is needed as the dynamic torque components are evaluated based on electrical measurements. However, as will be discussed later, some exemplary embodiments describe a situation in which available mechanical measurements at other components of the system, for example, the gas turbine, may be used to determine the dynamic torque components along the mechanical shaft.

In other words, an advantage according to an exemplary embodiment is applying torsional mode damping without the need of torsional vibration sensing in the mechanical system. Thus, torsional mode damping can be applied without having to install additional sensing in the electrical or mechanical system as current voltage and/or current and/or speed sensors can be made available at comparably low cost. In this regard, it is noted that mechanical sensors for measuring torque are expensive for high power applications, and sometimes these sensors cannot be added to the existing systems. Thus, the existent torsional mode damping solutions cannot be implemented for such cases as the existent torsional mode damping systems require a sensor for measuring a signal representative of a mechanical parameter of the system that is indicative of torque. On the contrary, the approach of the exemplary embodiment of FIG. 5 is reliable, cost effective and allows retrofitting an existing system.

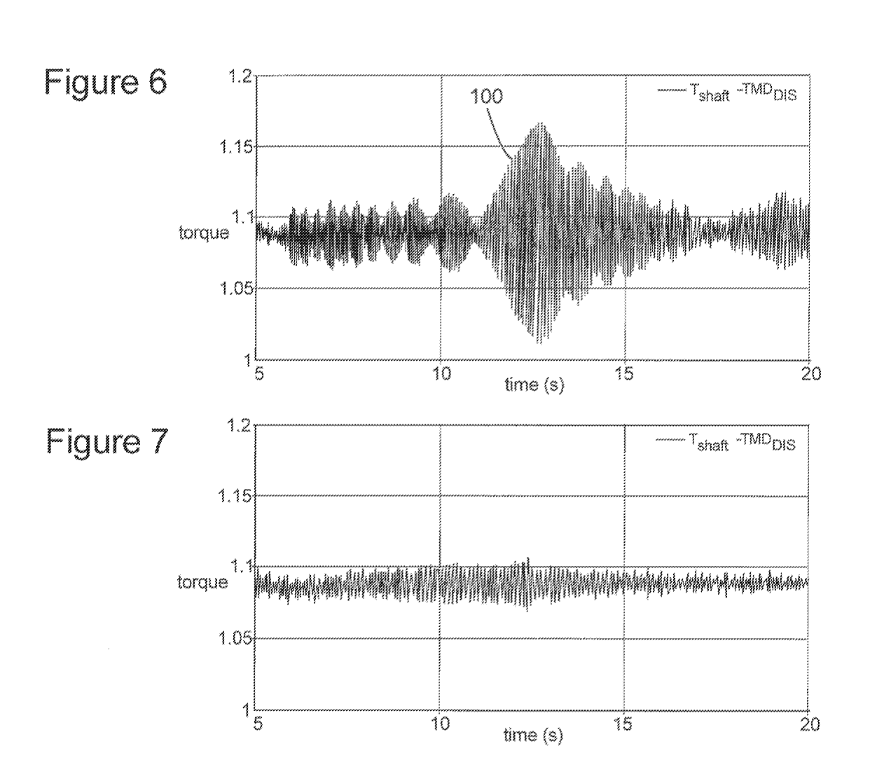

Upon receiving the current and voltage indicated in FIG. 5, controller 78 may generate appropriate signals (modulations for one or more of Δα and Δβ) for controlling the rectifier delay angle α and/or the inverter delay angle β. Thus, according to the embodiment shown in FIG. 5, the controller 78 receives measured electrical information from an output 91 of the inverter 70 and determines/calculates the various delay angles, based, for example, on the damping principle described in U.S. Pat. No. 7,173,399. In one application, the delay angles may be limited to a narrow and defined range, for example, 2 to 3 degrees, not to affect the operation of the inverter and/or converter. In one application, the delay angles may be limited to only one direction (either negative or positive) to prevent commutation failure by overhead-firing of the thyristors. As illustrated in FIG. 5, this exemplary embodiment is an open loop as corrections of the various angles are not adjusted/verified based on a measured signal (feedback) of the mechanical drive train connected to motor 54. Further, simulations performed show a reduction of the torsional vibrations when the controller 78 is enabled. FIG. 6 shows oscillations 100 of the torque of the shaft of the motor 54 versus time when the controller 78 is disabled and FIG. 7 shows how the same oscillations are reduced/damped when the controller 78 is enabled to generated alpha modulation, for example, at time 40 s, while the mechanical drive train is operated in variable speed operation and crossing at t=40 s a critical speed. Both figures plot a simulated torque on the y axis versus time on the x axis.

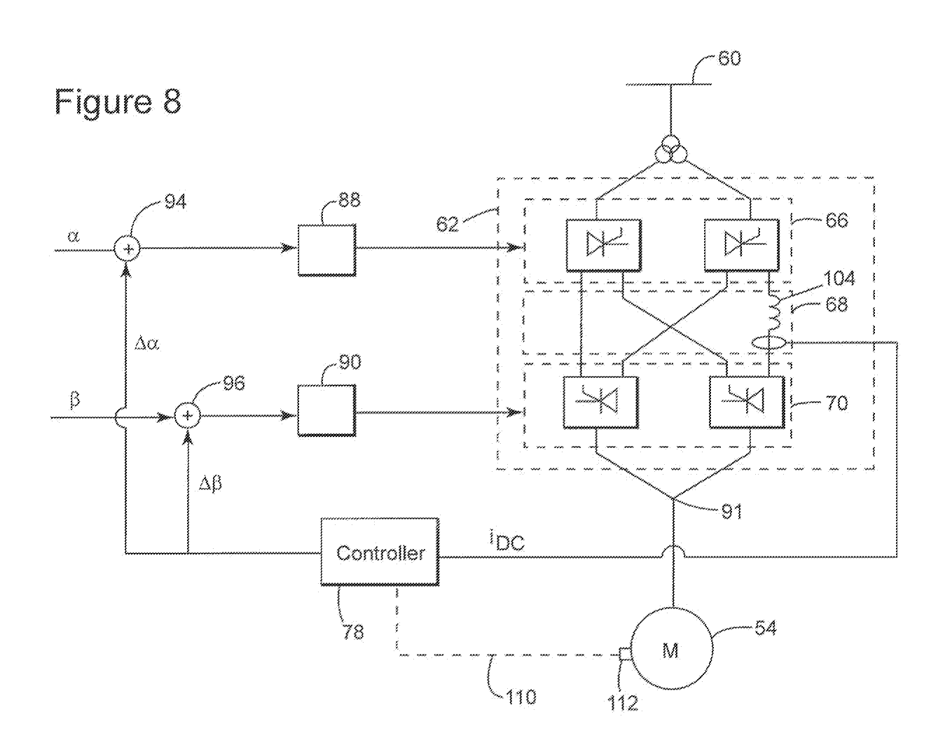

According to another exemplary embodiment illustrated in FIG. 8, the controller 78 may be configured to calculate one or more of the delay angles changes (modulations) Δα and/or Δβ based on electrical quantities obtained from the DC link 68. More specifically, a current i_{DC} may be measured at an inductor 104 of the DC link 68 and this value may be provided to controller 78. In one application, only a single current measurement is used for feeding controller 78. Based on the value of the measured current and the mechanical model of the system, the controller 78 may generate the above noted delay angle changes. According to another exemplary embodiment, the direct current I_{DC} may be estimated based on current and/or voltage measurements performed at the rectifier 66 or inverter 70

The delay angle changes calculated by the controller 78 in any of the embodiments discussed with regard to FIGS. 5 and 8 may be modified based on a closed loop configuration. The closed loop configuration is illustrated by dashed line 110 in FIG. 8. The closed loop indicates that an angular position, speed, acceleration, or torque of the shaft of the motor 54 may be determined with an appropriate sensor 112 and this value may be provided to the controller 78. The same is true if sensor or sensors 112 are provided to the gas turbine or other locations along shaft 58 shown in FIG. 3.

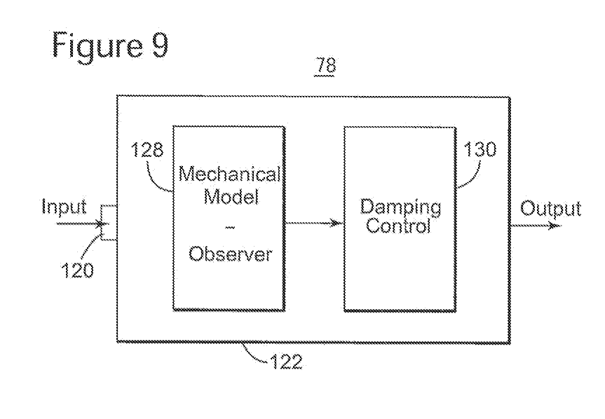

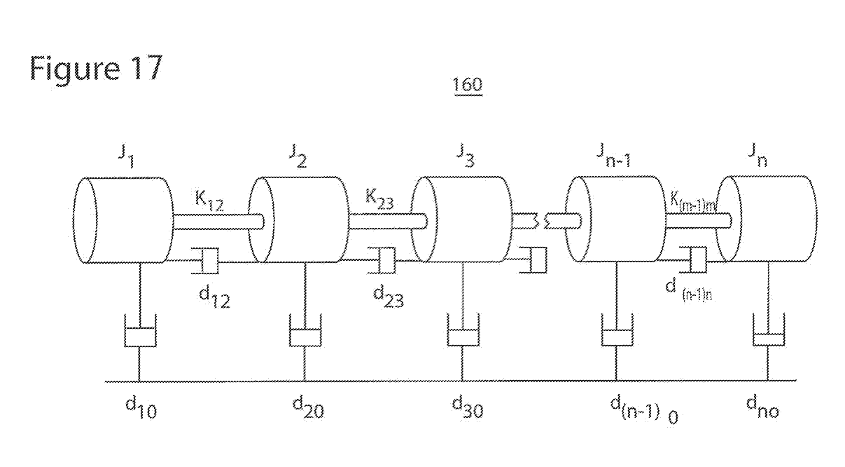

The structure of the controller 78 is discussed now with regard to FIG. 9. According to an exemplary embodiment, the controller 78 may include an input interface 120 that is connected to one of a processor, analog circuitry, reconfigurable FPGA card, etc. 122. Element 122 is configured to receive the electrical parameters from the LCI 62 and calculate the delay angle changes. Element 122 may be configured to store a mechanical model 128 (disclosed in more details with regard to FIG. 17) and to input the electrical and/or mechanical measurements received at input interface 120 into the mechanical model 128 to calculate one or more of the dynamical torque components of the motor 54. Based on the one or more dynamical torque components, damping control signals are generated in damping control unit 130 and the output signal is then forwarded to a summation block and a gate control unit. According to another exemplary embodiment, the controller 78 may be an analog circuit, a reconfigurable FPGA card or other dedicated circuitry for determining the delay angle changes.

In one exemplary embodiment, controller 78 continuously receives electrical measurements from various current and voltage sensors and continuously calculates torsional damping signals based on dynamic torque components calculated based on the electrical measurements. According to this exemplary embodiment, the controller does not determine whether torsional vibrations are present in the shaft but rather continuously calculates the torsional damping signals based on the calculated dynamic torque value. However, if there are no torsional vibrations, the torsional damping signals generated by the controller and sent to the inverter and/or rectifier are not affecting the inverter and/or rectifier, that is, the angle changes provided by the damping signals are negligible or zero. Thus, according to this exemplary embodiment, the signals affect the inverter and/or rectifier only when there are torsional vibrations.

According to an exemplary embodiment, the direct torque or speed measurement at the gas turbine shaft (or estimated speed or torque information in the shaft) enables the controller to modulate an energy transfer in the LCI in counter-phase to the torsional velocity of a torsional oscillation. Damping power exchanged between the generator and the LCI drive max be electronically adjusted and may have a frequency corresponding to a natural frequency of the shaft system. This damping method is effective for mechanical systems with a high Q factor, that is, rotor shaft system made of steel with high torsional stiffness. In addition, this method of applying an oscillating electrical torque to the shaft of the motor and having a frequency corresponding to a resonant frequency of the mechanical system uses little damping power.

Therefore, the above discussed controller may be integrated into a drive system based on the LCI technology without overloading the drive system. This facilitates the implementation of the novel controller to new or existing power systems and makes it economically attractive. The controller max be implemented without having to change the existing power system, for example, extending the control system of one of the LCI drives in the island network.

If the LCI operational speed and torque is varied in a large range, the effectiveness of the torsional mode damping may depend on the grid-side converter current control performance. The torsional mode damping operation results in a small additional DC link current ripple at a torsional natural frequency. As a result, there are two power components at this frequency: the intended component due to inverter firing angle control and an additional component due to the additional current ripple. The phase and magnitude of this additional power component is function of system parameters, current control settings and point of operation. These components result in a power component that is dependent on current control and a component that is dependent on angle modulation.

According to an exemplar embodiment, two alternative ways of power modulation may be implemented by the controller. A first way is to directly use the current reference on the grid side (requires fast current control implementation), for example, α-modulation with a damping component. A second way is to modulate the grid-side and the machine-side angles, resulting into a constant dc-link current, for example, α-β-modulation with a damping frequency component. The current control on the grid-side is part of this damping control and therefore, the current control does not counteract the effect of the angle modulation. In this way, the damping effect is higher and independent from the current control settings.

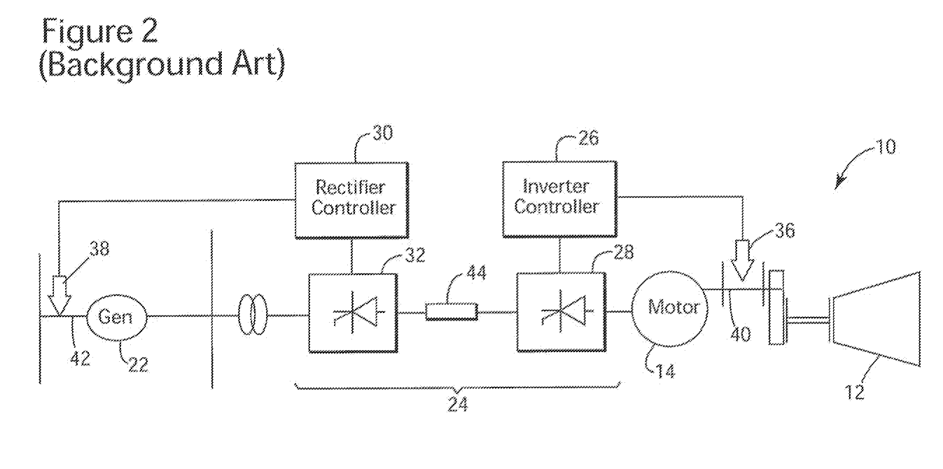

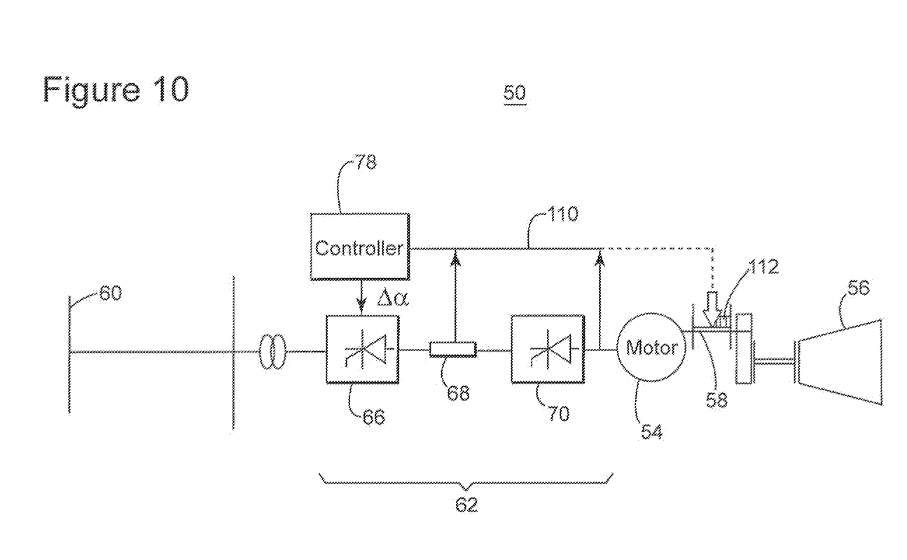

According to an exemplary embodiment illustrated in FIG. 10, the system 50 include similar elements to the system shown in FIGS. 3 and 4. Controller 78 is configured to receive electrical measurements (as shown in FIGS. 4, 5, and 8) and/or mechanical measurements (see for example FIGS. 4 and 8 or sensor 112 and link 110 in FIG. 10) with regard to one or more of the motor 54 or load 56 or the gas turbine (not shown) of system 50. Based only on the electrical measurements, or only on the mechanical measurements, or on a combination of the two, the controller 78 generates control signals for applying α-modulation to the rectifier 66. For example, current reference modulation is achieved by α-modulation while the β angle is maintained constant at the inverter 70. The α-modulation is represented, for example, by Δα in both FIGS. 4 and 10. It is noted that this α-modulation is different from the one disclosed in U.S. Pat. No. 7,173,399 for at least two reasons. A difference is that the mechanical measurements (if used) are obtained in the present exemplary embodiment from a location along shaft 58 (that is, motor 54, load 56 and/or gas turbine 52) while U.S. Pat. No. 7,173,399 uses a measurement of a power generator 22 (see FIG. 2). Another difference is that according to an exemplary embodiment, no mechanical measurements are received and used by the controller 78 for performing the α-modulation.

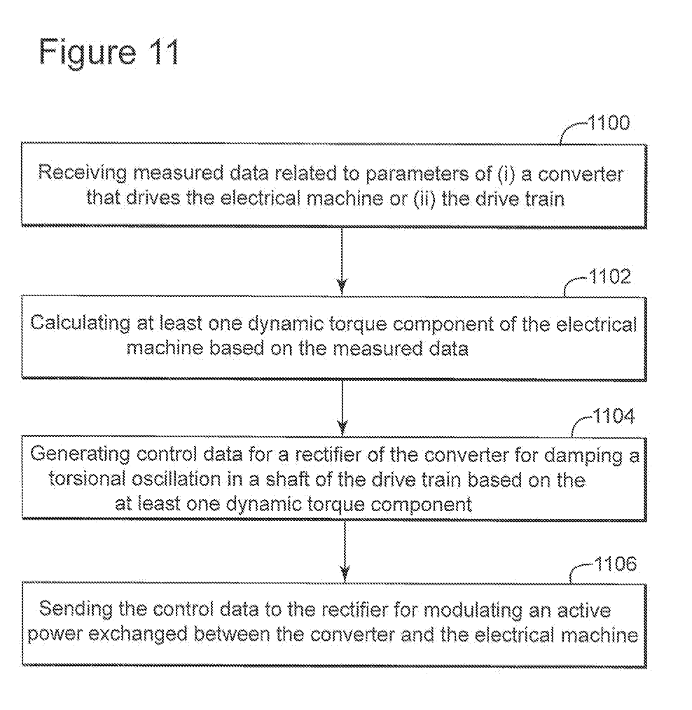

According to an exemplary embodiment illustrated in FIG. 11, there is a method for damping a torsional vibration in a compression train including an electrical machine. The method includes a step 1100 of receiving measured data related to parameters of (i) a converter that drives the electrical machine or (ii) the compression train, a step 1102 of calculating at least one dynamic torque component of the electrical machine based on the measured data, a step 1104 of generating control data for a rectifier of the converter for damping a torsional oscillation in a shaft of the compression train based on the at least one dynamic torque component, and a step 1106 of sending the control data to the rectifier for modulating an active power exchanged between the converter and the electrical machine.

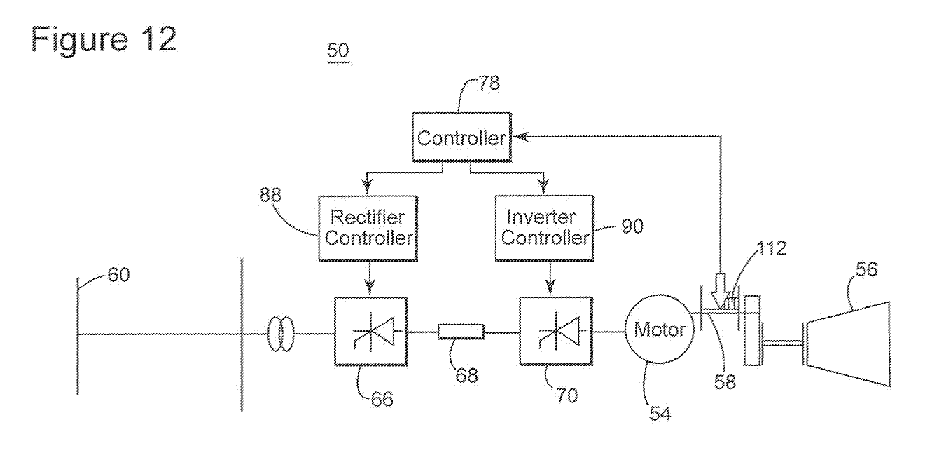

According to another exemplary embodiment illustrated in FIG. 12, system 50 may have both the rectifier 66 and the inverter 70 simultaneously controlled (that is, both α-modulation and β-modulation) for damping torsional oscillations. As shown in FIG. 12, controller 78 provides modulations for both the rectifier controller 88 and the inverter controller 90. Controller 78 determines the appropriate modulation based on (i) mechanical measurements measured by sensor(s) 112 at one of the motor 54, load 56 and/or gas turbine 52, (ii) electrical measurements as shown in FIGS. 4, 5, and 8, or a combination of (i) and (ii).

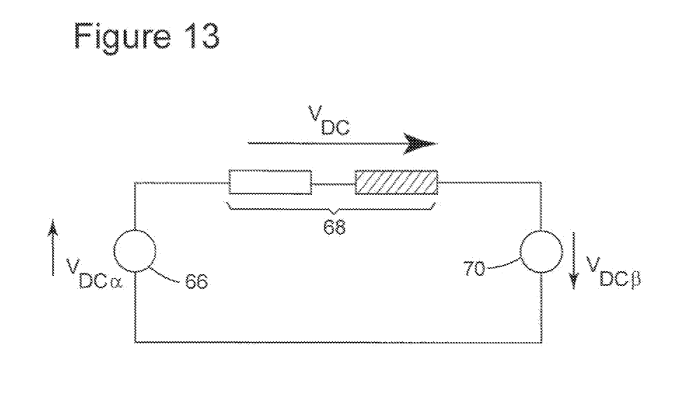

More specifically, the α- and β-modulation may be correlated as discussed next with reference to FIG. 13. FIG. 13 shows representative voltage drops across rectifier 66. DC link 68 and inverter 70. As a result of the α- and β-modulation it is desired that the DC link current is constant. Associated voltage drops shown in FIG. 13 are given by:

V_{DCα}=k·V_{ACG}·cos(α)

v_{DCβ}=k·V_{ACM}·cos(β), and

V_{DCα}=v_{DCβ}+V_{DCL},

where V_{ACG} (is the voltage line to line rms magnitude of the power grid 60 in FIG. 12 and V_{ACM} is the voltage line to line rms magnitude of the motor 54. Factor k is chosen based on the rectifier/inverter structure, for example, 3-sqrt(2)/pi for a B6C configuration.

By differentiating the last relation with time and imposing the condition that the change of the V_{DCL} in time is zero, the following mathematical relation is obtained between the α-modulation and the β-modulation:

d(V_{DCα})/dt=−k·V_{ACG}·sin(α) and d(V_{DCβ})/dt=−k·V_{ACM}·sin(β),

which results for a small signal variation around the operation point in

dα=(V_{ACM}·sin(β))/(V_{ACG}·sin(α))·dβ

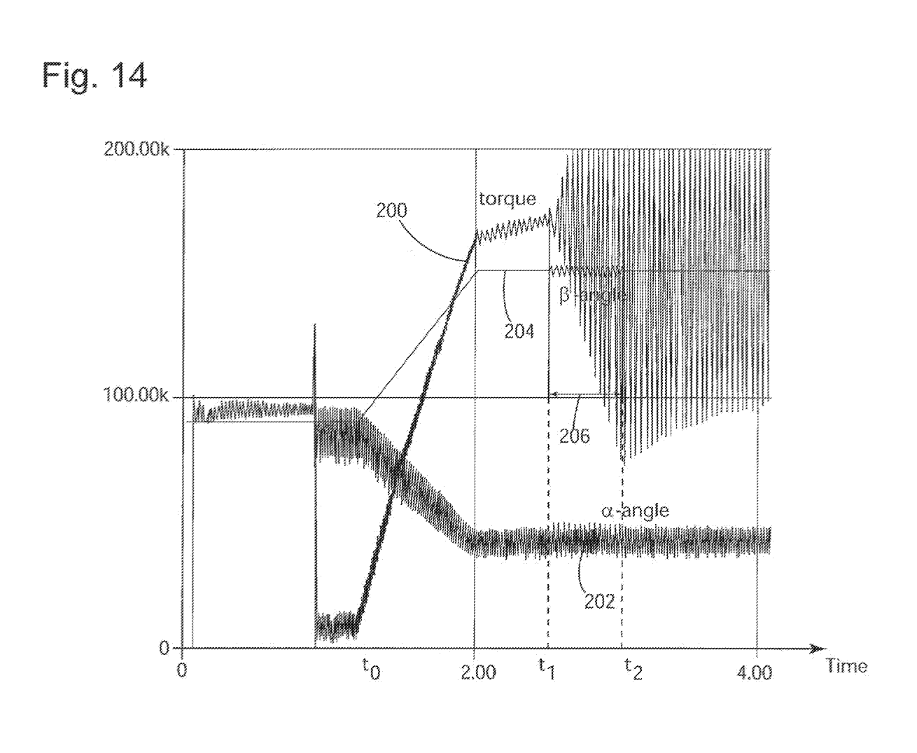

Based on this last relation, both the α-modulation and β-modulation are performed simultaneously, as shown for example, in FIG. 14. FIG. 14 shows the actual torque 200 increasing around t₀=1.5 seconds. It is noted that no a-modulation 202 or β-modulation 204 is applied between t₀ and t₁. At t₁ an excitation 206 is applied between t₁ and t₂ and both modulations 202 and 204 are applied. At the end of the time interval t₁ to t₂ it is noted that both modulations are removed and the oscillations of the torque 200 is exponentially decreasing because of the inherent mechanical damping properties of the mechanical drive train. This exemplary example is simulated and not measured in a real system. For this reason, both modulations are strictly controlled, for example, are started at t₁ and stopped at t₂. However, in a real implementation of the α-modulation and β-modulation, the modulations may be performed continuously with the amplitude of the modulation being adjusted based on the severity of the torsional oscillations. An advantage of this combined modulation over the β-modulation is that there is no need for phase adaptation at different operating points and the LCI control parameters may have no effect on the damping performance. This modulation example is provided to illustrate the effect of modulating both delay angles on the mechanical system. The simulation result is shown using an open loop response to the mechanical system for the torsional damping system with in verse damping performance.

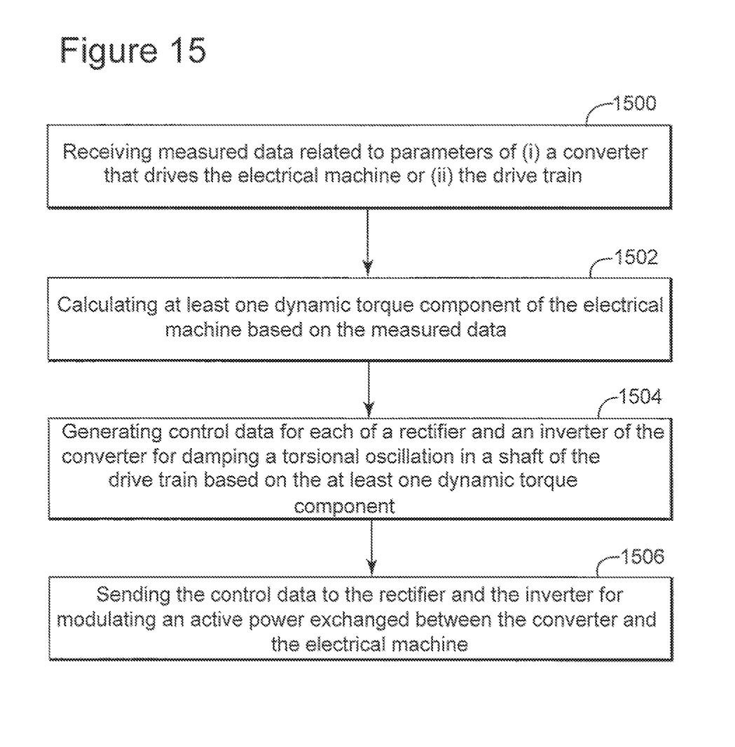

According to an exemplary embodiment illustrated in FIG. 15, there is a method for damping a torsional vibration in a drive train including an electrical machine. The method includes a step 1500 of receiving measured data related to parameters of (i) a converter that drives the electrical machine or (ii) the drive train, a step 1502 of calculating at least one dynamic torque component of the electrical machine based on the measured data, a step 1504 of generating control data for each of an inverter and a rectifier of the converter for damping a torsional oscillation in a shaft of the drive train based on the at least one dynamic torque component and a step 1506 of sending the control data to the inverter and the rectifier for modulating an active power exchanged between the converter and the electrical machine. It is noted that the dynamic torque component includes a rotational position, rotational speed, rotational acceleration or a torque related to a section of the mechanical shaft. It is also noted that the expression modulating an active power expresses the idea of modulation at an instant even if the mean active power over a period T is zero. In addition, if a VSI is used instead of an LCI another electrical quantity may be modified as appropriate instead of the active power.

According to an exemplary embodiment illustrated in FIG. 16, a VSI 140 includes a rectifier 142, a DC link 144, and an inverter 146 connected to each other in this order. The rectifier 142 receives a grid voltage from a power source 148 and may include, for example, a diode bridge or an active front-end based on self-commutated semiconductor devices. The dc voltage provided by the rectifier 142 is filtered and smoothed by capacitor C in the DC link 144. The filtered dc voltage is then applied to the inverter 146, which may include self-commutated semiconductor devices, for example. Insulated Gate Bipolar Transistors (IGBT), that generate an ac voltage to be applied to motor 150. Controllers 152 and 154 may be provided for rectifier 142 and inverter 146, in addition to the rectifier and inverter controllers or integrated with the rectifier and inverter controllers, to damp torsional vibrations on the shaft of the motor 150. The rectifier controller 153 and inverter controller 155 are shown connected to some of the semiconductor devices but it should be understood that all the semiconductor devices may be connected to the controllers. Controllers 152 and 154 may be provided together or alone and they are configured to determine dynamic torque components based on electrical measurements as discussed with regard to FIGS. 4 and 5 and influence control references of the built-in rectifier and inverter control, for example, the torque or current-control reference.

According to an exemplary embodiment illustrated in FIG. 17, a generalized multimass system 160 may include “n” different masses having corresponding moments of inertia J₁ to Jₙ. For example, the first mass may correspond to a gas turbine, the second mass may correspond to a compressor, and so on while the last mass may correspond to an electrical motor. Suppose that the shaft of the electrical motor is not accessible for mechanical measurements, for example, rotational position, speed, acceleration or torque. Further, suppose that the shaft of the gas turbine is accessible and one of the above noted mechanical parameters may be directly measured at the gas turbine. In this regard, it is noted that generally a gas turbine has highly accurate sensors that measure various mechanical variables of the shaft for protecting the gas turbine from possible damages. On the contrary, a conventional motor does not have these sensors or even if some sensors are present, the accuracy of their measurements is poor.

The differential equation of the whole mechanical system is given by:

J(dθ²/dt²)+D(dθ/dt)+Kθ=Tₑₓₜ,

where J (torsional matrix), D (damping matrix), and K (torsional stiffness matrix) are matrices connecting the characteristics of the first mass (for example, d₁₀, d₁₂, k₁₂, J₁) to the characteristics of the other masses and Tₑₓₜ is an external (net) torque applied to the system, for example, by a motor. Based on this model of the mechanical system, a torque or other dynamic torque component of the “n” mass may be determined if characteristics of, for example the first mass are known. In other words the highly accurate sensors provided in the gas turbine may be used to measure at least one of a torsional position, speed, acceleration or torque of the shaft of the gas turbine. Based on this measured value, a dynamic torque component of the motor (“n” mass) or another section of the drive train may be calculated by a processor or controller 78 of the system and thus, control data may be generated for the inverter or rectifier as already discussed above.

In other words, according to this exemplary embodiment, the controller 78 needs to receive mechanical related information from one turbo-machinery that is connected to the motor and based on this mechanical related information the controller is able to control the converter to generate a torque in the motor to damp the torsional vibration. The turbo-machinery may be not only a gas turbine but also a compressor, an expander or other known machines. In one application, no electrical measurements are necessary for performing the damping. However, the electrical measurements may be combined with mechanical measurements for achieving the damping. In one application, the machine that applies the damping (damping machine) is not accessible for mechanical measurements and the dynamic torque component of the damping machine is calculated by mechanical measurements performed on another machine that is mechanically connected to the damping machine.

The disclosed exemplary embodiments provide a system and a method for damping torsional vibrations. It should be understood that this description is not intended to limit the invention. On the contrary, the exemplary embodiments are intended to cover alternatives, modifications and equivalents, which are included in the spirit and scope of the invention as defined by the appended claims. For example, the method may be applied to other electric motor driven mechanical systems, such as large water pumps, pumped hydro power stations, etc. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using only devices or systems and performing any incorporated methods. The patentable scope of the subject matter is defined by the claims, and may include other examples that occur to those skilled in the art. Such other examples are intended to be within the scope of the claims.

What is claimed is:

1. A torsional mode damping controller system connected to a converter that drives a drive train including an electrical machine and a non-electrical machine, the controller system comprising:
an input interface configured to receive measured data related to variables of the converter or the drive train; and
a controller connected to the input interface and configured to,
calculate at least one dynamic torque component along a section of a shaft of the drive train based on the measured data from the input interface,
generate control data for a rectifier and an inverter of the converter for damping a torsional oscillation in the shaft of the drive train based on the at least one dynamic torque component, and
send the control data to the rectifier and to the inverter for modulating an active power exchanged between the converter and the electrical machine.

2. The controller system of claim 1, wherein the control data α-modulates the rectifier and β-modulates the inverter such that the α-modulation is correlated to the β-modulation.

3. The controller system of claim 1, wherein the controller is configured to insert in the control data a sinusoidal wave or sinusoidal half-wave to be applied to a rectifier delay angle and to an inverter delay angle.

4. The controller system of claim 3, wherein an amplitude of the sinusoidal wave is less than 3 degrees.

5. The controller system of claim 1, wherein the controller is configured to continuously perform the α-angle modulation of the rectifier and the β-angle modulation of the inverter.

6. The controller system of claim 1, wherein the controller is configured to generate the control data based only on measured data related to electrical variables of the converter.

7. The controller system of claim 1, wherein the controller is configured to generate the control data based only on measured data related to mechanical variables of the drive train.

8. The controller system of claim 1, wherein the controller is configured to generate the control data based only on measured data related to mechanical variables of the drive train except the electrical machine.

9. A system for driving an electrical machine that is part of a drive train, the system comprising:
a rectifier configured to receive an alternative current from a power source and to transform the alternative current into a direct current;
a direct current link connected to the rectifier and configured to transmit the direct current;
an inverter connected to the direct current link and configured to change a received direct current into an alternative current;
an input interface configured to receive measured data related to variables of the converter or the drive train; and
a controller connected to the input interface and configured to,
calculate at least one dynamic torque component along a section of a shaft of the drive train based on the measured data from the input interface,
generate control data for the rectifier and for the inverter for damping a torsional oscillation in the shaft of the mechanical system based on the at least one dynamic torque component, and
send the control data to the rectifier and the inverter for modulating an active power exchanged between the converter and the electrical machine.

10. A method for damping a torsional vibration in a drive train including an electrical machine, the method comprising:
receiving measured data related to variables of a converter that drives the electrical machine or the drive train or both the converter and the drive train;
calculating at least one dynamic torque component along a section of a shaft of the drive train based on the measured data;
generating control data for a rectifier and an inverter of the converter for damping a torsional oscillation in the shaft of the drive train based on the at least one dynamic torque component; and
sending the control data to the rectifier and the inverter for modulating an active power exchanged between the converter and the electrical machine.
